(19) United States
(12) Patent Application Publication
(10) Pub. No.: US 2021/0308819 A1
(43) Pub. Date: Oct. 7, 2021

(54) PROCESS FOR RESURFACING PLASTIC LENS

(71) Applicant: COLON CLIVE BLACK, Goshen, IN (US)

(72) Inventor: COLON CLIVE BLACK, Goshen, IN (US)

(73) Assignee: E. I. DU PONT DE NEMOURS AND COMPANY, Wilmington, DE (US)

(21) Appl. No.: 13/320,067

(22) PCT Filed: May 10, 2010
(86) PCT No.: PCT/US10/34206

§ 371 Date: Jul. 30, 2012

Related U.S. Application Data
(60) Provisional application No. 61/178,159, filed on May 14, 2009.

(51) Int. Cl. B24B 13/015

(52) U.S. Cl. CPC B24B 13/015

(57) ABSTRACT

The present invention is directed to a process for resurfacing a damaged surface of plastic lenses, such as vehicle headlights and taillights to restore the plastic lens surface to its original clarity and transparency. During process, a cleaned damaged surface is preferably orbital sanded with a moistened sand paper disc mounted on a sander for removing visible scratches and yellowing of the moistened damaged surface of the plastic lens. Thereafter, the sanded surface is preferably rotary polished with the slush-resistant polishing composition of the present invention applied on a polishing pad mounted on an polisher for removing any visible score marks that may have been created during the sanding step. Then, the polished surface is preferably rotary finished with the slush-resistant finishing composition of the present invention applied on a finishing pad mounted on a finisher for removing any visible swirls marks that may have been created during the polishing step.

### FIELD OF INVENTION

The present invention is directed to a process for resurfacing headlights or rear lights of vehicles and more particularly directed to a process that substantially reduces the contamination of the work area during the resurfacing process.

### BACKGROUND OF INVENTION

It is becoming increasingly common to use shaped lenses as headlight or rear light covers of vehicles instead of headlights or rear lights of a standardized shape that are generally made of glass. Typically, these lenses are made of transparent plastic (clear or tinted), such as polycarbonate, to shape them in conformity to the vehicle profile. Typical varied conditions experienced by vehicles operating on the roads subject such plastic lenses to dirt, ice particles, acid rain, ultraviolet light, grime, mud, stone chips, sand, etc. As a result, the surface of such plastic lenses, over time, tends to get foggy, hazy, scratched, yellowed, or a combination of the aforementioned damages. Since these plastic lenses tend to be an integral part of headlight or taillight assemblies, it becomes prohibitively expensive to replace them. So a need exists for resurfacing or restoring such plastic lenses to their original clarity without adversely affecting the structural integrity and strength of such plastic lenses. To keep the resurfacing cost as well as to reduce the time required to resurface such lenses, service providers prefer to not dismantle them from the vehicle during the resurfacing process.

One approach to refinishing plastic headlight lens on an automobile is described in U.S. Pat. No. 7,404,988 to Kuta (hereafter Kuta). The Kuta process consists of sanding under a water-flush, the damaged lens surface with progressively finer grit of sand paper discs mounted on an oscillating device followed by buffing and polishing. The buffed surface is then coated with an ultraviolet hardenable transparent material, which is then exposed to ultraviolet light. The foregoing process utilizes buffing compounds, such as those supplied by Dico Products Corporation of Utica, N.Y., over a buffing wheel. As can be seen in FIG. 1 of Kuta, substantial contamination and spillage is created in using the Kuta process. Therefore, a need still exists for a process that creates minimal or negligible spillage and splatter of components used during the resurfacing process. As a result, wastage of buffing and polishing components can be minimized and fewer amounts of such components can be used in repairing the lens damage, thereby reducing the cost of the resurfacing process.

### STATEMENT OF INVENTION

The present invention is directed to a process for resurfacing a damaged surface of a plastic lens located on a vehicle comprising:
a. cleaning said damaged surface with soap and water or a cleaner to remove wax, grease, silicone, dirt, tar, insect remnants, dust, sludge, or a combination thereof;
b. masking painted area of said vehicle surrounding said auto lens with a masking tape to prevent damage to said painted area;
c. positioning a sand paper disc containing aluminum oxide or silicon carbide abrasive particles on a disc mount of a sander, said abrasive particles having a grit in the range of 600 to 1500 particles per square inch of said sandpaper disc;
d. sanding said damaged surface with said orbital sander while soaking said sand paper disc and said damaged surface with water;
e. wiping said sanded surface dry before inspecting said damaged surface;
f. repeating said steps (d) and (e) until all visible scratches on damaged surface are removed;
g. loading a polishing pad having mounted on a polisher with a slush-resistant polishing composition, said slush-resistant polishing composition comprising:
   i. 8 parts to 15 parts of a stearic acid selected form the group consisting of hexadecanoic acid (palmitic acid), octadecanoic acid and a combination thereof;
   ii. 15 parts to 21 parts of an aliphatic solvent;
   iii. 5 parts to 9 parts of calcined abrasive alumina having particle size in the range of 3 to 5 micrometers; and
   iv. 60 parts to 75 parts of calcined abrasive alumina having particle size less than 1 micrometer, all parts in weight based on 100 parts of said slush-resistant polishing composition;
h. polishing said sanded surface with said polisher with said polishing pad spinning at 600 RPM to 1400 RPM;
i. repeating said steps (g) and (h) until all visible scoring marks on said sanded surface are removed;
j. loading a finishing pad mounted on a finisher with a slush-resistant finishing composition, said slush-resistant finishing composition comprising:
   i. 12 parts to 19 parts of a stearic acid selected form the group consisting of hexadecanoic acid (palmitic acid), octadecanoic acid and a combination thereof;
   ii. 11 parts to 18 parts of an aliphatic solvent;
   iii. 67 parts to 73 parts of calcined abrasive alumina having a particle size in the range of 0.5 to 6 micrometers, all parts in weight based on 100 parts of said slush-resistant finishing composition;
k. finishing said polished surface with said finisher with said foam finishing pad spinning at 600 RPM to 1200 RPM;
l. repeating said steps (j) and (k) until all visible swirl marks on said polished surface are removed; and
m. removing said masking tape form said painted area rod said vehicle.

### DETAILED DESCRIPTION OF PREFERRED THE EMBODIMENT

These and other features and advantages of the present disclosure will be more readily understood, by those of ordinary skill in the art, from a reading of the following detailed description. It is to be appreciated those certain features of the disclosure, which are, for clarity, described above and below in the context of separate embodiments, may also be provided in combination in a single embodiment. Conversely, various features of the disclosure that are, for brevity, described in the context of a single embodiment, may also be provided separately or in any sub-combination. In addition, references in the singular may also include the plural (for example, “a” and “an” may refer to one, or one or more) unless the context specifically states otherwise.

The use of numerical values in the various ranges specified in this application, unless expressly indicated otherwise, are stated as approximations as though the minimum and maximum values within the stated ranges were both preceded by the word “about.” In this manner, slight variations above and below the stated ranges can be used to achieve substantially the same results as values within the ranges. In addition, the disclosure of these ranges is intended as a continuous range including every value between the minimum and maximum values.

The process of the present invention is directed to resurfacing a damaged surface of a plastic lens located on a vehicle. Plastic lenses can be covers for headlights, taillights, directional lights and various other types of exterior light covers that are typically present on the vehicles, such as automobiles, trucks for various kinds and motorcycles. Typically, surface damage of a plastic lens results from exposure to road debris, such as dirt, ice particles, acid rain, grime, mud, stone chips and sand. In addition, the damage can also result from acid rain and exposure to ultraviolet light from sun. Since these housing assemblies are typically quite complex, they are generally difficult to remove from the bodies of the vehicles. Thus, it is desirable to resurface of the damaged surfaces of the plastic lenses without removing them from the vehicles.

The process includes cleaning the damaged surface with soap and water to remove external lens abrading elements, such as wax, grease, silicone, dirt, tar, insect remnants, dust, sludge, or a combination thereof. Alternately, clean rags soaked with a conventional cleaner such as, DuPont 3900 Cleaner supplied by E. I. du Pont de Nemours and Company (hereafter DuPont) can be used. If a cleaner is used, it should be of the type that does not chemically attack or damage the surface of the plastic lens, such as 3900 Cleaner supplied by DuPont. By removing the aforementioned abrading elements that may be present on the surface of the lens, further damage to the lens can be prevented during the resurfacing process of the present invention.

Typically, an area surrounding the plastic lens of the headlights or taillights on a vehicle is painted. To prevent damaging the paint on such a area surrounding the plastic lens during the resurfacing process of the present invention, it is masked, typically with a masking tape.

A conventional sander can be used for sanding the damaged surface while the damaged surface is continuously soaked with water to prevent damaging of the plastic lens surface due to overheating during the sanding operation. The sander suitable for use in the present invention can be either an orbital or rotary sander if the scratches are deep. Alternatively, a random dual action orbital sander can be used if the scratched are shallow. However, a care must be taken while using the orbital or rotary sander to prevent excessive heat build-up on the plastic lens surface by ensuring that the lens surface is kept wet and the sander is moved against the damaged surface in an evenly constant motion. Orbital sanders are preferred. Some of the suitable orbital sanders include CP7200S Mini Air Random Orbit Sander supplied by Chicago Pneumatic of Charlotte, N.C., AOS368 105° Angle Random Orbital Sander supplied by Grex of Alhambra, Calif., Porter Cable 7424 Variable-Speed Random-Orbit Polisher supplied by Porter Cable Company of Towson Md., FLEX XC 3401 dual action orbital polisher supplied by Flex gmbH of Stuttgart, Germany or 21000 Dynorbital-Spirit Random Orbital Sander supplied by Dynabrade of Clarence, Calif.

A suitable sandpaper disc is mounted on a disc mount of the sander. Some of the suitable sandpaper discs include those containing aluminum oxide, silicon carbide, garnet or ceramic particles as an abrasive medium having a grit ranging from 600 to 1500 abrasive particle per square inch of the sandpaper disc. Aluminum oxide abrasive particles are preferred. For heavier oxidation and damage, sandpaper discs having lower grit size of about 800 abrasive particle per square inch of the sandpaper disc can be used. Some of the suitable sandpaper discs include three-inch diameter Trizact™ Hookit™ II P1000 Blending Discs supplied by 3M Corporation of Maplewood, Minn. The damaged surface is orbital or rotary sanded to remove the visible scratches and yellowing of the plastic lens. Orbital sanding is preferred. Typically speeds in the range of 800 revolutions per minute (RPM) to 1400 RPM are suitable. When using circular or rotary sander speeds as low as 700 RPM to 900 RPM are suitable to prevent excessive heat build up on the plastic lens surface. The sanded surface is wiped with a clean rag and inspected. If necessary, the aforedescribed steps are the repeated until substantially all of the visible scratches or yellowing on the damaged surface is removed.

A conventional rotary or orbital polisher is suitable for use in the next phases of the process with the present invention. Some of the suitable polishers include the Makita 9227C polisher supplied by Makita U.S.A. Inc. of La Mirada, Calif., FLEX LK603VVB Circular Polisher supplied by Flex gmbH of Stuttgart, Germany, 18055 Rotary Polisher supplied by Dyanabrade of Clarence Calif. or DeWalt 849 Variable Speed Polisher supplied by DeWalt Products Company of Lancaster, Pa. Rotary polishers are preferred.

Thereafter, a foam-polishing pad mounted on a conventional polisher is loaded with a slush-resistant polishing composition of the present invention, which includes 8 parts to 15 parts of a stearic acid selected from the group consisting of hexadecanoic acid (palmitic acid), octadecanoic acid and a combination thereof all parts in weight based on 100 parts of the slush-resistant polishing composition. Triple pressed grade, which is a mixture substantially containing octadecanoic acid and hexadecanoic acid (Cas. #57-11-4) supplied by Emery Industries of Cincinnati, Ohio as Emersol 132 stearic acid is preferred. The composition also includes 15 parts to 21 parts of an aliphatic solvent. The aliphatic solvent (Cas. #64742-47-8) supplied by Calumet Penreco, LLC of Indianapolis, Ind. as Drakesol 205, which is a petroleum distillate that includes C₉ to C₁₆ carbon containing saturated hydrocarbons, is preferred. The composition further includes 5 parts to 9 parts of calcined abrasive alumina having particle size in the range of 3 to 5 micrometers, and 60 parts to 75 parts of calcined abrasive alumina having particle size less than 1 micrometer. Calcined abrasive alumina (Al₂O₃) particles having particle size in the range of 3 to 5 micrometers supplied by AluChem Inc. of Reading, Ohio, as AC-12 aluminum oxide abrasive, is preferred. Calcined abrasive alumina (Al₂O₃) having particle size less than 1 micrometer (Cas. #1344-28-1) supplied by AluChem Inc. of Reading, Ohio, as AC-13 aluminum oxide abrasive is preferred.

A number of minor conventional components may also be present in the slush-resistant polishing composition, such as binder polymers, preservatives, pigments, dyes. Suitable preservatives include diazolidinyl urea designated as GERMALL II®, methylparaben (methyl p-hydroxybenzoate), and propylparaben (propyl p-hydroxybenzoate), which may be present in concentrations ranging, respectively, from 0 part to about 0.3 part, from 0 part to about 0.2 part, and from 0 part to part 0.1 percent, all by weight based on 100 parts of the slush-resistant polishing composition. GERMALL II® diazolidinyl urea is commercially available from Sutton Laboratories of Chatham, N.J. In addition to its use as a preservative, GERMALL II® can be also employed to prevent discoloration of the slush-resistant polishing composition and to give it a pastel color. Alternately, phenoxyethanol methyldibromo glutyaronitrile designated as EUXYL K-400® and supplied by Schülke & Mayr of Mount Arlington, N.J., can be used as a preservative.

Generally, the slush-resistant polishing composition is prepared in a conventional steam jacketed kneader wherein, the stearic acid in a molten state is poured into the kneader along with or in any desired sequence the rest of the components. The mixture is then kneaded until all of the components are uniformly dispersed in the mixture. The kneaded mixture is then preferably extruded in the form of a polishing stick inside a corrugated paper tube that can then be peeled off, as needed, to expose the composition therein. The size of the polishing stick can vary from 1.5 inches to 2.5 inches in diameter.

It should be noted that conventional polishing compositions, which are either in liquid, paste or dry powder form, when applied over polishing pads spinning at high revolutions, tend to fly off the pads. As a result, significant portions of the conventional polishing compositions is not only wasted but these conventional polishing compositions also substantially contaminate the work area of the work shop surrounding the vehicle, which then has to be cleaned. By contrast, the slush-resistant polishing composition of the present invention has the right consistency that substantially minimizes or eliminates the spillage and wastage of the slush-resistant polishing composition during the use.

In order to efficiently apply the slush-resistant polishing composition on the foam polishing pad, the exposed part of the polishing stick jutting out is rubbed against the face of the polishing pad, from the center of the polishing pad to its periphery while the polishing pad, mounted on the conventional polisher, is spinning at 600 revolutions per minute (RPM) to 1400 RPM. Generally, one to three passes are sufficient to coat the face of the polishing pad with a desired amount of the slush-resistant polishing composition. Various types of polishing pads are suitable for the polishing step, such as for example, those made from wool or foam. Foam pads are preferred. Depending on the size of the plastic lens surface being resurfaced, the size of the polishing pads can be selected. The polishing pads varying in size from 2 inches 10 inches in diameter and having flat or curved polishing surface can be utilized. Higher or lower sizes could be also used, if needed. Particularly preferred polishing pads are foam polishing pads supplied by Lake County Manufacturing, Inc. of Glenview, Ill. More preferred is an orange colored flat faced polishing pad supplied by Lake County Manufacturing, Inc. under the name #78-22350 Orange Light Polishing Pad having 3.5 inch diameter. The color of the foam polishing pads supplied by Lake County Manufacturing, Inc. indicates the degree of their hardness or softness.

The sanded surface of the plastic lens is then polished with the polishing foam pad loaded with the slush-resistant polishing composition and spinning at 600 RPM to 1400 RPM. Rotary or orbital polishing is suitable. Rotary polishing is preferred. The polished surface is then inspected. The foregoing steps are repeated until all of the visible scoring marks that may have been created during the sanding operation are removed.

During the aforedescribed polishing step, generally the polished surface tends to develop fine swirl marks, which have to removed to resurface the plastic lens surface substantially to its originals state. Therefore, a foam-finishing pad mounted on a conventional finisher is loaded with a slush-resistant finishing composition, which includes 12 parts to 19 parts of a stearic acid selected from the group consisting of hexadecanoic acid (palmitic acid), octadecanoic acid and a combination thereof all parts in weight based on 100 parts of the slush-resistant polishing composition. Triple pressed grade, which is a mixture substantially containing octadecanoic acid and hexadecanoic acid (Cas. #57-11-4) supplied by Emery Industries of Cincinnati, Ohio as Emersol 132 stearic acid is preferred. The composition further includes 11 parts to 18 parts of an aliphatic solvent. The aliphatic solvent (Cas. #64742-47-8) supplied by Calumet Penreco, LLC of Indianapolis, Ind. as Drakesol 205, which is a petroleum distillate that includes C₉ to C₁₆ carbon containing saturated hydrocarbons, is preferred. The composition further includes 67 parts to 73 parts of calcined abrasive alumina having particle size in the range of 0.5 to 6 micrometers. Calcined abrasive alumina having average size of 1.5 micrometers supplied under the name MICROGRIT PXA#301 by Micro Abrasives Corporation of Westfield, Mass. is preferred. Another alternative is calcined abrasive alumina having a particle size in the range of 0.5 to 4 micrometers, which is supplied by Micro Abrasives Corporation under the name MICROGRIT PXA#401 having average particle size of 1 micrometer. Still another alternative is calcined abrasive alumina having a particle size in the range of 0.5 to 2 micrometers, which is supplied by Micro Abrasives Corporation under the name MICROGRIT PXA#411 having average particle size of 0.75 micrometer.

The finishing composition can include a number of minor conventional components, such as binder polymers, preservatives, pigments, dyes. Suitable preservatives include diazolidinyl urea designated as GERMALL II®, methylparaben (methyl p-hydroxybenzoate), and propylparaben (propyl p-hydroxybenzoate), which may be present in concentrations ranging, respectively, from 0 part to about 0.3 part, from 0 part to about 0.2 part, and from 0 part to part 0.1 percent, all by weight based on 100 parts of the slush-resistant finishing composition. GERMALL II® diazolidinyl urea is commercially available from Sutton Laboratories of Chatham, N.J. In addition to its use as a preservative, GERMALL II® can be also employed to prevent discoloration of the slush-resistant finishing composition and to give it a pastel color. Alternately, phenoxyethanol methyldibromo glutyaronitrile designated as EUXYL K-400® and supplied by Schülke & Mayr of Mount Arlington, N.J., can be also used as a preservative.

Generally, the slush-resistant finishing composition is prepared in a conventional steam jacketed kneader wherein, the stearic acid in a molten state is poured into the kneader along with or in any desired sequence the rest of the components. The mixture is kneaded until all of the components are uniformly dispersed in the mixture. The kneaded mixture is then preferably extruded in the form of a finishing stick inside a corrugated paper tube that can then be peeled off, as needed, to expose the composition therein. The size of the finishing stick can vary from 1.5 inches to 2.5 inches in diameter.

It should be noted that conventional finishing compositions, which are either in liquid, paste or dry powder form, when applied over finishing pads spinning at high revolutions, tend to fly off the pads. As a result, significant portion of the conventional finishing compositions is not only wasted but these conventional finishing compositions also substantially contaminate the work area of the work shop surrounding the vehicle, which then has to be cleaned. By contrast, the slush-resistant finishing composition of the present invention has the right consistency that substantially minimizes or eliminates the spillage and wastage of the slush-resistant finishing composition during the use.

In order to efficiently apply the slush-resistant finishing composition on the finishing pad, the exposed part of the finishing stick jutting out is rubbed against the face of the finishing pad, from the center of the finishing pad to its periphery while the finishing pad, mounted on the conventional finisher, is spinning at 600 revolutions per minute (RPM) to 1200 RPM. Preferably two to three passes are made to coat the face of the finishing pad with a desired amount of the slush-resistant finishing composition. Various types of finishing pads are suitable for finishing operation, such as for example, those made from wool or foam. Foam pads are preferred. Depending on the size of the plastic lens surface being resurfaced, the size of the finishing pads can be selected. The finishing pads varying in size from 2 inches 10 inches in diameter and having flat or curved polishing surface can be utilized. Higher or lower sizes could be also used, if needed. Particularly preferred finishing pads are those supplied by Lake County Manufacturing, Inc. of Glenview, Ill. More preferred is a flat faced finishing pad supplied by Lake County Manufacturing, Inc. under the name #78-72350 black colored finishing Pad having 3.5 inch diameter. The color of the foam finishing pads supplied by Lake County Manufacturing, Inc. indicates the degree of their hardness or softness.

Thereafter, the polished surface is finished using the finisher with the finishing pad spinning at 600 RPM to 1200 RPM. Orbital or rotary finishing can be used. Rotary finishing is preferred. The finished surface is then inspected. The foregoing steps are repeated until all of the visible swirl marks that may have been created during the polishing operation are removed. The finisher can be the same as the polishers described earlier.

After the foregoing steps, the masking tape from the painted area is removed.

It should be noted that polisher or finisher could be the same device, such as 18055 Rotary Polisher supplied by Dyanabrade of Clarence Calif.

### EXAMPLES

### Compositions

A slush-resistant polishing composition was prepared by kneading under heat in a kneader mixer 12 parts of Emersol® 132 stearic acid, 18 parts of Drakesol® 205 solvent, 7 parts of A-12 calcined alumina abrasive and 63 parts of A-12 calcined alumina abrasive, all parts in weight based on the total weight of the composition. The hot mixture was then extruded into a cardboard tube of about 1.5 inches diameter and about 5 inches in the length and cooled to form the polishing stick of the present invention.

A slush-resistant finishing composition was prepared by kneading under heat in a kneader mixer 15.5 parts of Emersol® 132 stearic acid, 14.5 parts of Drakesol® 205 solvent, 70 parts of MICROGRIT PXA #301 calcined alumina abrasive, all parts in weight based on the total weight of the composition. The hot mixture was then extruded into a cardboard tube of about 1.5 inches diameter and about 5 inches in the length and cooled to form the finishing stick of the present invention.

### Resurfacing Process

A damaged plastic headlight lens on an automobile was cleaned with 3900 Cleaner supplied by DuPont and the painted area surrounding the damaged plastic lens was masked with a masking tape to prevent damaging the painted surface underneath during the resurfacing process of the present invention.

The damaged surface was then orbital sanded with P1000 grit sand paper disc mounted on an orbital sander Chicago Pneumatic CP7200S Mini Air Random Orbit Sander after continuously soaking the sandpaper and the damaged surface during the sanding step with water to prevent heat build-up. The sander was moved constantly across the damaged surface in an even uniform motion to prevent scoring or overheating the plastic surface. The sanded surface was then wiped clean and inspected. The foregoing steps were repeated until all of the visible scratches and yellowing on the damaged plastic lens surface were removed.

The exposed end of the polishing stick of the present invention was then rubbed twice from the center to periphery of #78-22350 orange polishing pad supplied by Lake County Manufacturing, Inc., which was mounted on a polisher, which was 18055 Rotary Polisher supplied by Dyanabrade of Clarence Calif. spinning at 1000 RPM to ensure substantial smearing of the face of the polishing pad with the polishing composition of the present invention. Unlike the conventional polishing compositions, the slush-resistant polishing composition of the present invention did not splatter off of the spinning polishing pad during he application.

The sanded surface of the plastic lens was then rotary polished with the aforedescribed polishing pad mounted on the polisher and spinning as 1000 RPM to remove visible score marks generated during the sanding operation. The polished surface was then wiped clean and inspected. The foregoing steps were repeated until all of the visible score marks on the sanded plastic lens surface were removed.

The exposed end of the finishing stick of the present invention was then rubbed twice from the center to periphery of #78-72350 black finishing pad supplied by Lake County Manufacturing, Inc., which was mounted on a finisher spinning at 1000 RPM to ensure substantial smearing of the face of the finishing pad with the finishing composition of the present invention. The finisher was the same as 18055 Rotary Polisher supplied by Dyanabrade of Clarence Calif. Unlike the conventional finishing compositions, the slush-resistant finishing composition of the present invention did not splatter off of the spinning finishing pad during use.

The polished surface of the plastic lens was then rotary finished with the aforedescribed finishing pad mounted on the finisher spinning as 1000 RPM to remove visible swirl marks that may have generated during the polishing operation. The finished surface was then wiped clean and inspected. The foregoing steps were repeated until all of the visible swirls on the polished plastic lens surface were removed.

The masking tape on the painted area surrounding the plastic lens was removed. The resurfaced plastic lens of the headlight of an automobile then had the same clarity and transparency as that of an undamaged plastic lens without defiling the work area or without the loss of the slush-resistant polishing and finishing compositions.

What is claimed is:

1. A process for resurfacing a damaged surface of a plastic lens located on a vehicle comprising:
(a) cleaning said damaged surface with soap and water or a cleaner to remove wax, grease, silicone, dirt, tar, insect remnants, dust, sludge, or a combination thereof;
(b) masking painted area of said vehicle surrounding said auto lens with a masking tape to prevent damage to said painted area;
(c) positioning a sand paper disc containing aluminum oxide or silicon carbide abrasive particles on a disc mount of a sander, said abrasive particles having a grit in the range of 600 to 1500 particles per square inch of said sandpaper disc;
(d) sanding said damaged surface with said orbital sander while soaking said sand paper disc and said damaged surface with water;
(e) wiping said sanded surface dry before inspecting said damaged surface;
(f) repeating said steps (d) and (e) until all visible scratches on damaged surface are removed;
(g) loading a polishing pad having mounted on a polisher with a slush-resistant polishing composition, said slush-resistant polishing composition comprising:
I. 8 parts to 15 parts of a stearic acid selected form the group consisting of hexadecanoic acid (palmitic acid), octadecanoic acid and a combination thereof;
II. 15 parts to 21 parts of an aliphatic solvent;
III. 5 parts to 9 parts of calcined abrasive alumina having particle size in the range of 3 to 5 micrometers; and
IV. 60 parts to 75 parts of calcined abrasive alumina having particle size less than 1 micrometer, all parts in weight based on 100 parts of said slush-resistant polishing composition;
(h) orbital polishing said sanded surface with said polisher with said polishing pad spinning at 600 RPM to 1400 RPM;
(i) repeating said steps (g) and (h) until all visible scoring marks on said sanded surface are removed;
(j) loading a finishing pad mounted on a finisher with a slush-resistant finishing composition, said slush-resistant finishing composition comprising:
I. 12 parts to 19 parts of a stearic acid selected form the group consisting of hexadecanoic acid (palmitic acid), octadecanoic acid and a combination thereof;
II. 11 parts to 18 parts of an aliphatic solvent;
III. 67 parts to 73 parts of calcined abrasive alumina having a particle size in the range of 0.5 to 6 micrometers, all parts in weight based on 100 parts of said slush-resistant finishing composition;
(k) rotary finishing said polished surface with said finisher with said foam finishing pad spinning at 1200 RPM to 1200 RPM;
(l) repeating said steps (j) and (k) until all visible swirl marks on said polished surface are removed; and
(m) removing said masking tape form said painted area rod said vehicle.

2. The process of claim 1 wherein said plastic lens is a headlamp cover or a rear lamp cover.

3. The process of claim 1 or 2 wherein said vehicle is an automobile, truck, motorcycle or other lighted vehicle.

4. The process of claim 1 wherein said loading step (g) comprises rubbing said slush-resistant polishing composition jutting out of a polishing stick from a center of a face of said polishing pad to the periphery of said face when said polishing pad is spinning at 600 RPM to 1400 RPM.

5. The process of claim 4 wherein said rubbing step is repeated two or more times.

6. The process of claim 1 wherein said loading step w comprises rubbing said slush-resistant finishing composition jutting out of a finishing stick from a center of a face of said finishing pad to the periphery of said face when said finishing pad is spinning at 600 RPM to 1200 RPM.

7. The process of claim 6 wherein said rubbing step is repeated two or more times.

8. The process of claim 1 wherein said sander, polisher and finisher are a same device.

9. The process of claim 1 wherein said polishing pad is an orange colored flat faced foam polishing pad having three-inch diameter.

10. The process of claim 1 wherein said finishing pad is a black colored flat faced foam finished pad having three-inch diameter.

11. The process of claim 1 comprising removing said masking tape form said painted area.

12. A headlamp cover or a rear lamp cover resurfaced by the process of claim 1.

13. The process of claim 12 wherein said vehicle is an automobile, truck, motorcycle or other lighted vehicle.
